(19) United States
(12) Patent Application Publication
(10) Pub. No.: US 2005/0221845 A1
(43) Pub. Date: Oct. 6, 2005

(54) Cordless and cellular communication session handoff

(76) Inventors: David S. Benco, Winfield, IL (US); Kevin J. Overend, Elmhurst, IL (US); Baoling S. Sheen, Naperville, IL (US); Sandra L. True, St. Charles, IL (US); Kenneth J. Voight, Sugar Grove, IL (US)

Correspondence Address: LUCENT TECHNOLOGIES INC.;DOCKET ADMINISTRATOR, 101 CRAWFORDS CORNER ROAD - ROOM 3J-219, HOLMDEL, NJ, 07733, US

(21) Appl. No.: 10/818,216

(22) Filed: Apr. 5, 2004

(51) Int. Cl. H04Q 7/20

(52) U.S. Cl. 455/462; 455/444

(57) ABSTRACT

A method comprises the step of performing a handoff of an active communication session of a mobile communication device between a cordless phone base station and a cellular base station.

### TECHNICAL FIELD

The invention relates generally to cellular communications and more particularly to cellular communication handoffs.

### BACKGROUND

Cordless phones provide limited mobile capabilities to users of a landline telephone. Although current cordless technologies allow for extended ranges up to several thousand feet and more, cordless phones can not provide a coverage area equal to a cellular phone. The difference in coverage areas offered by cellular phones and cordless phones is a key factor in determining a cost for cellular phone and cordless phone usage. Since cellular phones require more investment in infrastructure and maintenance, a cost for a call placed from a cellular phone is significantly higher than that of a call placed from a cordless phone.

For users that have both a cordless phone and a cellular phone, a choice must be made between the cordless phone and the cellular phone when placing a call. If the user anticipates traveling outside the coverage area of the cordless phone, they may choose the cellular phone for increased mobility. Alternatively, if the user does not anticipate traveling outside the coverage area of the cordless phone, they may choose the cordless phone for a cheaper cost. Once the call has been placed, the user is not able to switch between the cordless phone and the cellular phone. The inability to switch between the cordless phone and the cellular phone decreases a cost efficiency for the user.

Thus, a need exists for an increase in cost efficiency for users of cordless and cellular phones.

### SUMMARY

In one embodiment, there is provided a method for performing a handoff of an active communication session of a mobile communication device between a cordless phone base station and a cellular base station.

In another embodiment, there is provided an apparatus comprising a mobile switching center that performs a handoff of an active communication session of a mobile communication device between a cellular base station and a cordless phone base station.

In yet another embodiment, there is provided an article comprising one or more computer-readable signal-bearing media. The article includes means in the one or more media for performing a handoff of an active communication session of a mobile communication device between a cordless phone base station and a cellular base station.

### DESCRIPTION OF THE DRAWINGS

Features of exemplary implementations of the invention will become apparent from the description, the claims, and the accompanying drawings in which:

FIG. 1 is a representation of one implementation of an apparatus that comprises a cellular network, a public switched telephone network, a mobile communication device, and a communications network.

FIG. 2 is a representation of one or more coverage areas of the cellular network and the public switched telephone network of the apparatus of FIG. 1.

### DETAILED DESCRIPTION

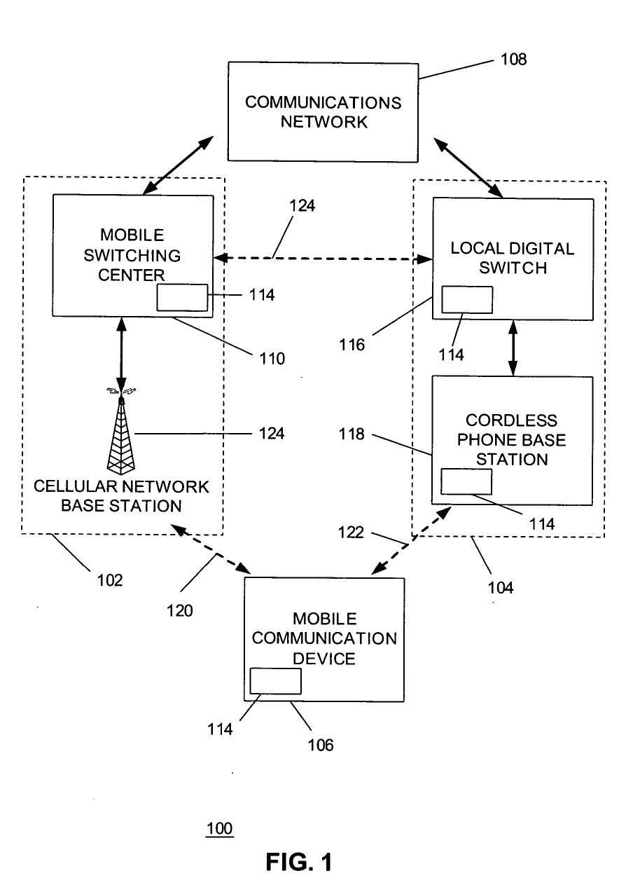

Turning to FIG. 1, an apparatus 100 in one example comprises a cellular network 102, a public switched telephone network 104, a mobile communication device 106, and a communications network 108. The cellular network 102 in one example comprises a code division multiple access (“CDMA”) cellular network, a universal mobile telephone system (“UMTS”) cellular network, or a third generation (“3G”) compatible cellular network. The cellular network 102 comprises one or more mobile switching centers 110 and one or more cellular base stations 112. The mobile switching center 110 in one example comprises an instance of a recordable data storage medium 114. The mobile switching center 110 and the cellular base station 112 cooperate to route calls to and/or from a cellular handset, for example, the mobile communication device 106, as will be appreciated by those skilled in the art.

The public switched telephone network (“PSTN”) 104 comprises one or more local digital switches 116 that route calls to and/or from one or more cordless phone base stations 118. The local digital switch 116 and/or the cordless phone base station 118 in one example comprise an instance of a recordable data storage medium 114. The cordless phone base station 118 in one example comprises a cordless phone base station in a users home. The cordless phone base station 118 employs one or more cordless technologies to communicate with a cordless handset, for example, the mobile communication device 106. Exemplary cordless technologies comprise 43/49 MHz, 900 MHz, 900 MHz digital spread spectrum, and 2.4 GHz technologies.

The mobile communication device 106 in one example comprises a mobile phone and/or personal digital assistant that is operable on both the cellular network 102 and the public switched telephone network 104. For example, the mobile communication device 106 comprises both a cordless handset and a cellular handset. The mobile communication device 106 in one example comprises an instance of a recordable data storage medium 114. The mobile communication device 106 establishes a communication path between the mobile communication device 106 and any of the cordless phone base station 118 or the cellular base station 112. In one example, the mobile communication device 106 establishes a communication path 120 with the cellular base station 112. In another example, the mobile communication device 106 establishes a communication path 122 with the cordless phone base station 118. The communication paths 120 and 122 comprise communication paths over an air interface. The mobile communication device 106 employs the communication paths 120 and/or 122 to send and/or receive calls, as will be appreciated by those skilled in the art.

The communications network 108 in one example comprises a cellular network, a public switched telephone network, or an internet protocol (“IP”) network. In one example, the communications network 108 and the cellular network 102 comprise a same network. In another example, the communications network 108 and the public switched telephone network 104 comprise a same network.

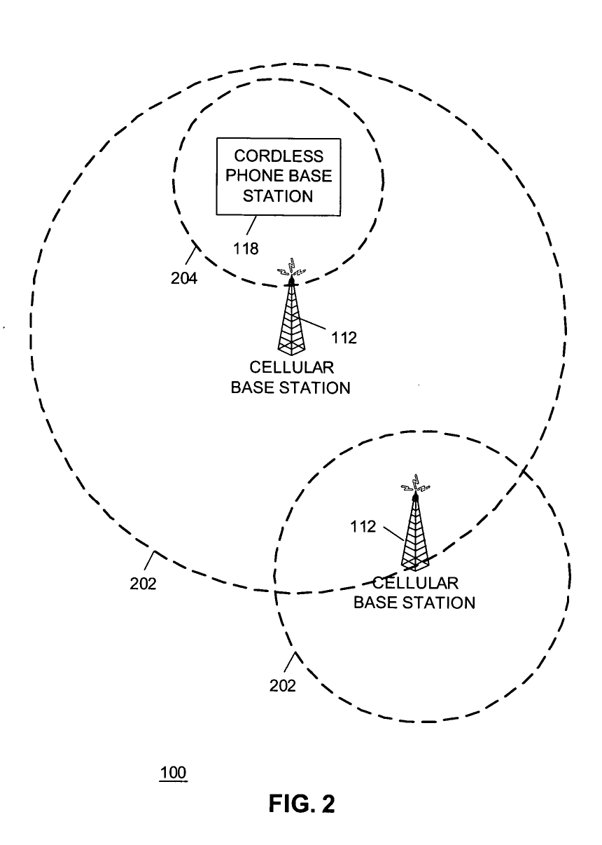

Turning to FIG. 2, the cellular base stations 112 comprise respective coverage areas 202. The mobile communication device 106 is able to establish the communication path 120 while substantially within the coverage areas 202. The cordless phone base stations 118 comprise a coverage area 204. The mobile communication device 106 is able to establish the communication path 122 while substantially within the coverage areas 204. The coverage areas 202 and 204 in one example comprise overlapping coverage areas, as will be appreciated by those skilled in the art.

An illustrative description of exemplary operation of the apparatus 100 is presented, for explanatory purposes. A user of the mobile communication device 106 is initially located within the coverage area 204 of the cordless phone base station 118. The user employs the mobile communication device 106 to create an active communication session with another user (not shown) of the communications network 108. For example, the user employs the mobile communication device 106 to place a call to the other user. The mobile communication device 106 establishes a communication path 122 with the cordless phone base station 118. The local digital switch 116 routes the call through the communications network 108 to the other user, as will be appreciated by those skilled in the art. spirit of the invention and these are therefore considered to be within the scope of the invention as defined in the following claims.

The mobile switching center 110, the local digital switch 116, and the mobile communication device 106 cooperate to perform a handoff of the active communication session. In one example, the mobile communication device 106 makes a determination to establish a communication path 120 between the mobile communication device 106 and the cellular base station 112. In another example, the local digital switch 116 makes the determination to establish the communication path 120 between the mobile communication device 106 and the cellular base station 112. In yet another example, the mobile switching center 110 makes the determination to establish the communication path 120 between the mobile communication device 106 and the cellular base station 112. The mobile communication device 106, the mobile switching center 110, and the local digital switch 116 cooperate to perform the handoff based on the determination to establish the communication path 120, as described herein.

The mobile communication device 106 in one example makes the determination to establish the communication path 120 based on one or more additional determinations. A first exemplary determination comprises a determination of proximity of the mobile communication device 106 to the cellular base station 112 and/or a proximity of the mobile communication device 106 to the cordless phone base station 118. For example, the mobile communication device 106 determines if the mobile communication device 106 is within the respective coverage area 202 and/or 204. A second exemplary determination comprises a determination of a signal strength between the mobile communication device 106 and the cellular base station 112 and/or a signal strength between the mobile communication device 106 and the cordless phone base station 118. For example, the mobile communication device 106 determines if the signal strength between the mobile communication device 106 and the cordless phone base station 118 is sufficiently strong for acceptable reception. A third exemplary determination comprises a determination of capacity of the cellular base station 112 and/or the cordless phone base station 118. A fourth exemplary determination comprises a determination of transmission costs over the communication paths 120 and 122. For example, which communication path is cheaper for transmission of the active communication session. A fifth exemplary determination comprises a determination of a user-defined preference for any of the communication paths 120 and 122. For example, a user-defined preference indicates that the communication path 120 should be used during a certain time to take advantage of a cellular service plan through the cellular network 102 that allows free nights and weekends. The user inputs one or more time periods to define the user-defined preferences, as will be appreciated by those skilled in the art.

Upon the determination to establish the communication path 120, the mobile communication device 106, the mobile switching center 110, and the local digital switch 116 cooperate to perform the handoff. The mobile communication device 106, the mobile switching center 110, and the local digital switch 116 cooperate to establish the communication path 120. The mobile switching center 110 in one example exchanges one or more messages 124 with the local digital switch 116 to perform the handoff. Exemplary messages 124 comprise signaling system seven (“SS7”), session initiation protocol (“SIP”), and integrated services digital network user part (“ISUP”) messages. The handoff in one example comprises a hard handoff, as will be appreciated by those skilled in the art.

Where the user of the mobile communication device 106 travels over a large distance and passes through several coverage areas 202 and/or 204, the respective mobile switching centers 110 and local digital switches 116 of the coverage areas 202 and/or 204 perform handoffs of the active communication session as needed. In one example, the mobile switching centers 110 and local digital switches 116 perform a handoff from the communication path 122 to the communication path 120. In another example, the mobile switching centers 110 and local digital switches 116 perform a handoff from the communication path 120 to the communication path 122.

The apparatus 100 in one example comprises a plurality of components such as one or more of electronic components, hardware components, and computer software components. A number of such components can be combined or divided in the apparatus 100. An exemplary component of the apparatus 100 employs and/or comprises a set and/or series of computer instructions written in or implemented with any of a number of programming languages, as will be appreciated by those skilled in the art.

The apparatus 100 in one example employs one or more computer-readable signal-bearing media. Examples of a computer-readable signal-bearing medium for the apparatus 100 comprise the recordable data storage media 114 of the mobile communication device 106, the mobile switching center 110, the local digital switch 116, and the cordless phone base station 118. For example, the computer-readable signal-bearing medium for the apparatus 100 comprises one or more of a magnetic, electrical, optical, biological, and atomic data storage medium. In one example, the computer-readable signal-bearing medium comprises a modulated carrier signal transmitted over a network comprising or coupled with the apparatus 100, for instance, one or more of a telephone network, a local area network (“LAN”), the internet, and a wireless network.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the

1. A method, comprising the step of:
performing a handoff of an active communication session of a mobile communication device between a cordless phone base station and a cellular base station.

2. The method of claim 1, wherein the step of performing the handoff of the active communication session of the mobile communication device between the cordless phone base station and the cellular base station comprises the steps of:
making a determination to establish a communication path between the mobile communication device and any of the cordless phone base station or the cellular base station; and
performing the handoff of the active communication session based on the determination to establish the communication path between the mobile communication device and any of the cordless phone base station or the cellular base station.

3. The method of claim 2, wherein the step of making the determination to establish the communication path between the mobile communication device and any of the cordless phone base station or the cellular base station comprises the step of:
determining a proximity of the mobile communication device to the cordless phone base station and/or a proximity of the mobile communication device to the cellular base station.

4. The method of claim 2, wherein the step of making the determination to establish the communication path between the mobile communication device and any of the cordless phone base station or the cellular base station comprises the step of:
determining a signal strength between the mobile communication device and the cordless phone base station and/or a signal strength between the mobile communication device and the cellular base station.

5. The method of claim 2, wherein the step of making the determination to establish the communication path between the mobile communication device and any of the cordless phone base station or the cellular base station comprises the step of:
determining a capacity of the cordless phone base station and/or a capacity of the cellular base station.

6. The method of claim 2, wherein the step of making the determination to establish the communication path between the mobile communication device and any of the cordless phone base station or the cellular base station comprises the step of:
determining a transmission cost associated with the cordless phone base station and/or a transmission cost associated with the cellular base station.

7. The method of claim 2, wherein the step of making the determination to establish the communication path between the mobile communication device and any of the cordless phone base station or the cellular base station comprises the step of:
determining a user-defined preference for a first communication path between the mobile communication device and the cellular base station and a second communication path between the mobile communication device and the cordless phone base station.

8. The method of claim 7, wherein the step of determining the user-defined preference for the first communication path between the mobile communication device and the cellular base station and the second communication path between the mobile communication device and the cordless phone base station comprises the step of:
receiving one or more user inputs for the user-defined preference for the first communication path between the mobile communication device and the cellular base station and the second communication path between the mobile communication device and the cordless phone base station.

9. The method of claim 2, wherein the mobile communication device and the cellular base station comprise a first communication path between the mobile communication device and the cellular base station for the active communication session, the method further comprising the step of:
establishing a second communication path between the mobile communication device and the cordless phone base station.

10. The method of claim 9, wherein the step of performing the handoff of the active communication session based on the determination to establish the communication path between the mobile communication device and any of the cordless phone base station or the cellular base station comprises the step of:
performing a handoff of the active communication session from the first communication path between the mobile communication device and the cellular base station to the second communication path between the mobile communication device and the cordless phone base station.

11. The method of claim 10, wherein the step of performing the handoff of the active communication session from the first communication path between the mobile communication device and the cellular base station to the second communication path between the mobile communication device and the cordless phone base station comprises the step of:
exchanging one or more messages with a local digital switch of a public switched telephone network that comprises the cordless phone base station to perform the handoff of the active communication session.

12. The method of claim 2, wherein the mobile communication device and the cordless phone base station comprise a first communication path between the mobile communication device and the cordless phone base station for the active communication session, the method further comprising the step of:
establishing a second communication path between the mobile communication device and the cellular base station.

13. The method of claim 12, wherein the step of performing the handoff of the active communication session based on the determination to establish the communication path between the mobile communication device and any of the cordless phone base station or the cellular base station comprises the step of:
performing a handoff of the active communication session from first communication path between the mobile communication device and the cordless phone base station to the second communication path between the mobile communication device and the cellular base station.

14. The method of claim 13, wherein the step of performing the handoff of the active communication session from first communication path between the mobile communication device and the cordless phone base station to the second communication path between the mobile communication device and the cellular base station comprises the step of:
exchanging one or more messages with a mobile switching center of a cellular communication network that comprises the cellular base station to perform the handoff of the active communication session.

15. An apparatus, comprising:
a mobile switching center that performs a handoff of an active communication session of a mobile communication device between a cellular base station and a cordless phone base station.

16. The apparatus of claim 15, wherein the mobile switching center communicates with a local digital switch to perform the handoff of the active communication session of the mobile communication device;
wherein the mobile switching center and the cellular base station comprise a portion of a cellular communication network;
wherein the local digital switch and the cordless phone base station comprise a portion of a public switched telephone network.

17. The apparatus of claim 16, wherein the mobile switching center and the local digital switch cooperate to perform a hard handoff of the active communication session of the mobile communication device.

18. An article, comprising:
one or more computer-readable signal-bearing media; and
means in the one or more media for performing a handoff of an active communication session of a mobile communication device between a cordless phone base station and a cellular base station.

19. The article of claim 18, wherein the means in the one or more media for performing a handoff of an active communication session of a mobile communication device between a cordless phone base station and a cellular base station comprises:
means in the one or more media for making a determination to establish a communication path between the mobile communication device and any of the cordless phone base station or the cellular base station;
means in the one or more media for performing the handoff of the active communication session based on the determination to establish the communication path between the mobile communication device and any of the cordless phone base station or the cellular base station.

20. The article of claim 19, wherein the means in the one or more media for making the determination to establish the communication path between the mobile communication device and any of the cordless phone base station or the cellular base station comprises:
means in the one or more media for determining:
a proximity of the mobile communication device to the cordless phone base station and/or a proximity of the mobile communication device to the cellular base station;
a signal strength between the mobile communication device and the cordless phone base station and/or a signal strength between the mobile communication device and the cellular base station;
a transmission cost associated with the cordless phone base station and/or a transmission cost associated with the cellular base station; and/or
a user-defined preference for a first communication path between the mobile communication device and the cellular base station and a second communication path between the mobile communication device and the cordless phone base station.
